(19) United States
(12) Patent Application Publication
(10) Pub. No.: US 2012/0193021 A1
(43) Pub. Date: Aug. 2, 2012

(54) STRUCTURES AND METHODS FOR MAKING SPORTS SHAFTS SUITABLE FOR GRAPHICS APPLICATION

(76) Inventors: Stanley Botten, Vashon Island, WA (US); Dean E. Wilson, Mercer Island, WA (US)

(21) Appl. No.: 13/152,196

(22) Filed: Jun. 2, 2011

Related U.S. Application Data
(60) Provisional application No. 61/438,838, filed on Feb. 2, 2011.

(51) Int. Cl. B44C 3/04

(52) U.S. Cl. 156/220

(57) ABSTRACT

A method for making a sports shaft include forming a negative image on an image-receiving surface of a flexible cover sheet, forming a first tube with a sheet of composite material, covering the first tube with the flexible cover sheet that has the negative image facing an outer surface of the first tube, and applying heat and pressure to cure the flexible cover sheet and the first tube by one or more molds to form a sports shaft having a composite core made of the composite material and the flexible cover sheet wrapped around the core and showing to the outside a positive image based on the negative image.

### CROSS-REFERENCE TO RELATED APPLICATIONS

The present application claims priority to U.S. Provisional Patent Application 61/438,838, entitled “Structures of and methods of making sports shafts suitable for graphic application”, filed Feb. 2, 2011 by the same inventors, the disclosure of which is incorporated herein by reference.

### BACKGROUND OF THE INVENTION

The present invention relates to the field of sports equipment, and in particular, a sports shaft that supports a basket or a blade at its end to allow a ball or a ‘puck’ in play.

Sports shafts, such as lacrosse shafts, usually include color patterns or designs on the exterior surfaces to identify the manufacturers and provide aesthetic appeal. Existing cosmetic applications include a rubberize substance, paint, or decals that lay on the surface of the shaft. These rubberized materials are typically applied by molding, shaping, extruding or hydra forming, or deep drawing on the outer surface of a pre-formed stick. For the veneer/wood covered shafts, these rubberized materials can be applied during the molding process. Graphics on the wood shaft can be applied before or after molding depending on the appearance desired for the graphics.

A drawback of the conventional sports shafts is that the colors and graphic display are easily scraped off by bumping, collisions, and abrasion when the shafts are used in playing games.

Some sports shafts are applied with some forms of graphics media that tend to improve grip. Such coatings, including rubber coatings, are usually not durable. Players often apply tapes around the sports shaft to improve their grips. Tapes are also often applied to other “stencil” or “silk-screened” shafts to enhance grip, as the surfaces of these sports shafts can be slippery and lack tactile feel for the players. When covered by tapes, the graphics on the sports shaft is useless in providing product identification and brand recognition as it is originally designed.

### SUMMARY OF THE INVENTION

In one aspect, the present invention relates to a method for making a sports shaft that includes forming a negative image, by a printing apparatus, on an image-receiving surface of a flexible cover sheet; obtaining a first tube with a sheet of composite material; covering the first tube with the flexible cover sheet that has the negative image facing an outer surface of the first tube; and applying heat and pressure to cure the flexible cover sheet and the first tube by one or more molds to form a sports shaft having a composite core made of the composite material and the flexible cover sheet wrapped around the core and showing to the outside a positive image based on the negative image.

Implementations of the system may include one or more of the following. The step of applying heat and pressure can include holding the flexible cover sheet and the first tube inside one or more molds; and applying pressure inside the first tube to press the first tube and the flexible cover sheet against the one or more molds. The method can further include inserting an elastic inflation tube into the first tube and inflating the elastic inflation tube by compressed air to press the first tube and the flexible cover sheet against the one or more molds. The step of applying heat and pressure can include heating the flexible cover sheet and the first tube to a temperature between about 180° F. to about 325° F. The negative image can be formed by a dye or an ink, wherein the method can further include before the step of forming a negative image, treating the image-receiving surface by heat, flame, the Corona process, sand blast, or a chemical to assist the adhesion of the dye or the ink to the image-receiving surface. The method can further include rolling the flexible cover sheet to form a second tube having the negative image facing inside, leaving the positive image visible from outside of the second tube, wherein the step of covering comprises inserting the first tube into the second tube. The flexible cover sheet can be formed by a material selected from the group consisting of a polymeric or a plastic material such as Nylon™, Polybutylene terephthalate (PBT), and co-extruded Nylon™ and PBT. The flexible cover sheet can be formed by a substantially transparent material. The flexible cover sheet can be formed by a translucent, a white, or substantially opaque material. The flexible cover sheet can have a thickness a range between about 0.01″ and about 0.04″. The flexible cover sheet can have a satin or matte finish on a cover surface opposing to the image-receiving surface. The negative image can be formed on the image-receiving surface of a flexible cover sheet using silk screen printing, ink jet printing or thermal dye sublimation printing.

In another aspect, the present invention relates to a method for making a sports shaft. The method includes forming a negative image on a transfer sheet by a printing apparatus, forming a first tube with a sheet of composite material, covering the first tube by a flexible cover sheet, placing the transfer sheet on the flexible cover sheet with the negative image facing an outer surface of the flexible cover sheet, applying heat and pressure to the flexible cover sheet and the first tube by one or more molds to cure the flexible cover sheet and the composite material in the first tube and to transfer the negative image to the outer surface of the flexible cover sheet; and removing the transfer sheet from the flexible cover sheet to form a sports shaft having a composite core made of the composite material and a flexible cover sheet wrapping around the core. The outer surface of the flexible cover sheet can be printed with a positive image based on the negative image.

Embodiments may include one or more of the following advantages. The present invention provides graphics to sports shafts with improved durability for the graphics and grips for the players, compared to the conventional sports shafts. The color printing is protected by a sheet of transparent material against abrasion and impact during the game play. The transparent material can be made of a material to improve grip and adhesion of feel of the shaft in players' hands, which eliminates the need for taping over the sports shaft and allows the branding and trademarks to be visible through the use lives of the sports shafts.

Another advantage of the disclosed sports shaft is that it can act as a cushion and can help dampen the feel of impact to the player's hands.

Additionally, the flexible cover sheet can also protect the players from sharp edges that ensue of shaft breakage as the plastic sheet tends to stretch over a breakage and prevents the shards from injuring the player or lessons the degree of injuries.

The present invention is applicable to a wide range of sports shafts such as lacrosse shafts, hockey sticks, and other shaft style tools, and various shaft cross-sectional shapes such as octagon, square, round, or oval cross sections.

Although the invention has been particularly shown and described with reference to multiple embodiments, it will be understood by persons skilled in the relevant art that various changes in form and details can be made therein without departing from the spirit and scope of the invention.

### BRIEF DESCRIPTION OF THE DRAWINGS

The following drawings, which are incorporated in and form a part of the specification, illustrate embodiments of the present invention and, together with the description, serve to explain the principles of the invention.

FIG. 1 illustrates the printing of a negative image on an image-receiving surface of a flexible cover sheet.

FIG. 2 illustrates the flexible cover sheet printed with a negative image on the image-receiving surface.

FIG. 3 illustrates the formation of a tube by the flexible cover sheet carrying the negative image on the image-receiving surface.

FIG. 4 shows that a tube-shaped of composite material is inserted inside the tube of the flexible cover sheet and the tube of the flexible cover sheet is fitted into a mold.

FIG. 5 shows the formation of a sport shaft having a core made of the composite material wrapped by the flexible cover sheet showing a positive image visible from the outside.

FIG. 6 shows a flowchart for forming a sports shaft in accordance with the present invention.

FIG. 7 shows a flowchart for forming a sports shaft in accordance with another embodiment of the present invention.

### DETAILED DESCRIPTION OF THE INVENTION

The present invention discloses a sport shaft that is covered by a flexible cover sheet that is printed with graphics such as identification, trademark, branding, and color text or images on its inner surface contacting the shaft surface. The flexible cover sheet can be molded to the shaft. The flexible cover sheet can be molded simultaneously during the molding of composite shafts, hydra-formed compressed air expansion, or other expanded molding process and forming techniques. The flexible cover sheet can also be molded to the sports shaft after the sports shaft is formed as in the case of extruded or formed alloy shafts.

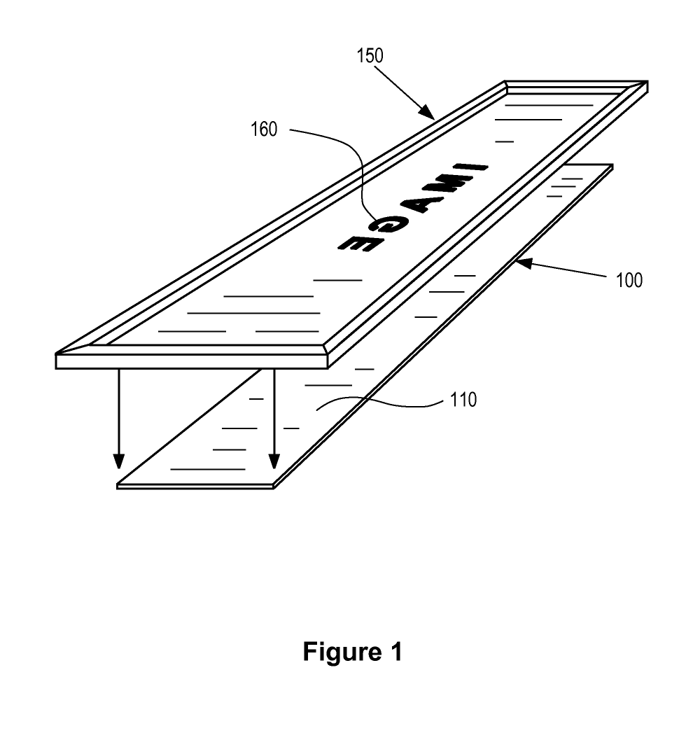

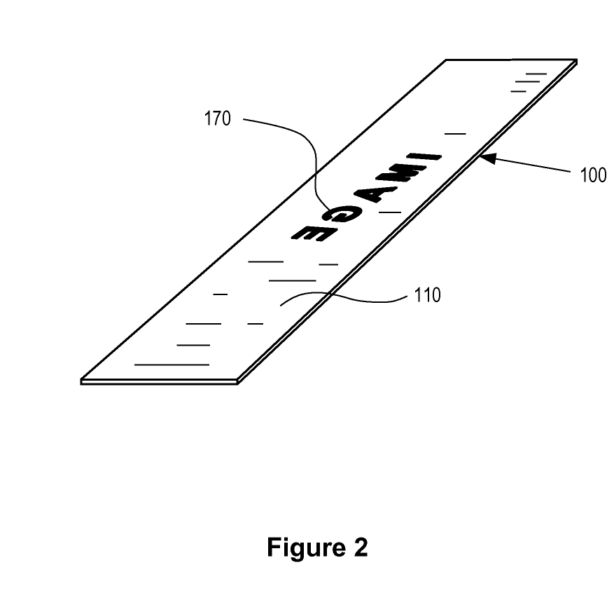

As shown in FIG. 1, a flexible cover sheet 100 includes an image-receiving surface 110. In most cases, the flexible cover sheet 100 is formed by a substantially transparent material. In some cases, the flexible cover sheet 100 can be translucent, white, or substantially opaque. (In these cases, the colorant can diffuse deep into the flexible cover sheet 100 and still make the positive image visible from outside, as shown in FIGS. 2-5 below). Suitable materials for the flexible cover sheet 100 can include a polymeric or a plastic material such as Nylon™, Polybutylene terephthalate (PBT), co-extruded Nylon™ and PBT, etc. The flexible cover sheet 100 can have a thickness in a range between about 0.01″ and about 0.04″, or about 0.02″ provide strength to sustain abrasion and impact during usage of the sports shaft to be formed.

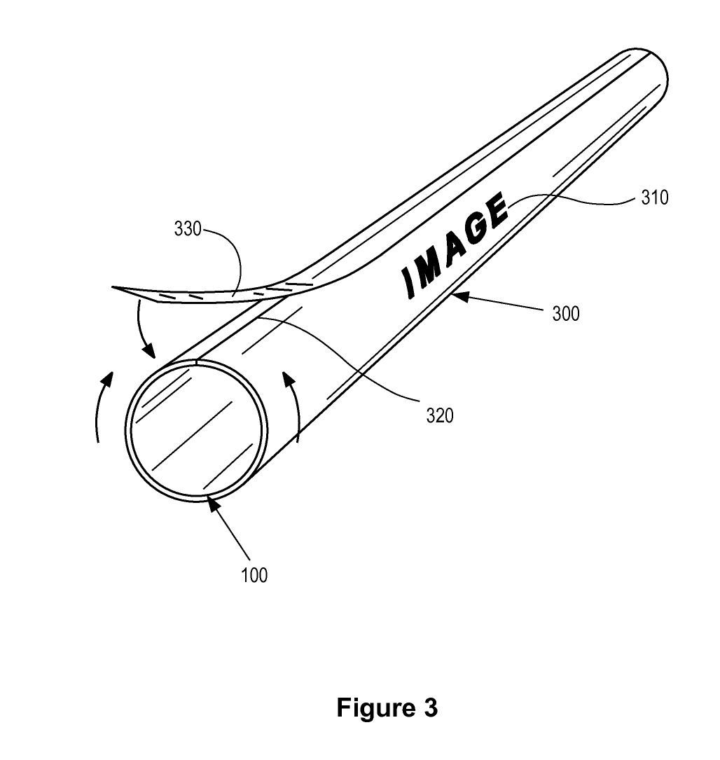

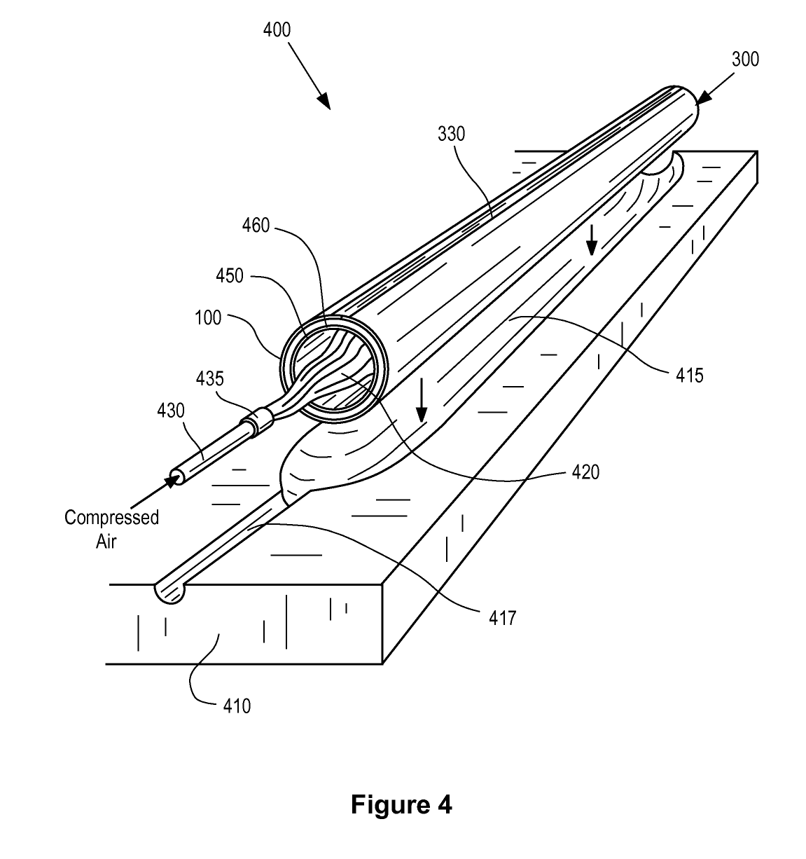

The image-receiving surface 110 can be treated by techniques such as heat, flame, the Corona process, sand blast, or chemicals. The treatments can alter the surface structure of the image-receiving surface 110 to make it more adhesive to the colorant to be printed, such as epoxy ink, and better adhesion to the composite material as describe below. The surface treatments can make the image-receiving surface 110 more easily adhere to the surface of the sports shafts (as shown in FIGS. 3 and 4 below) because the flexible cover sheet 100 normally does not easily adhere to the surface of the sports shaft, such as an alloy shaft.

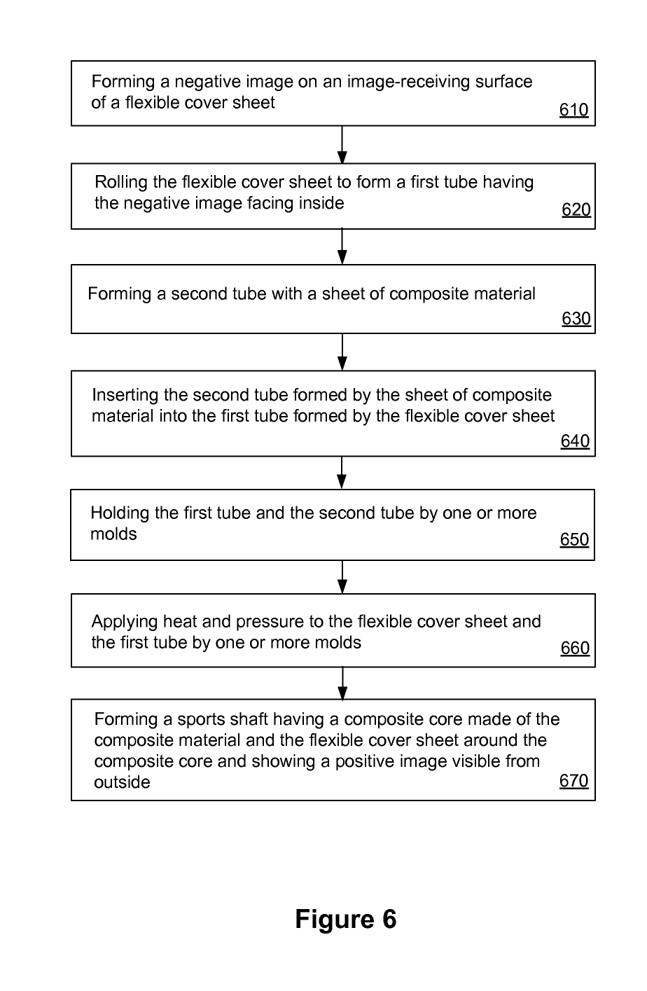

A silk screen printing device 150 is prepared with a layer of epoxy ink in a negative image 160, which corresponds to the intended graphics or image pattern to be displayed on the finished sports shaft. The screen printing device 150 is pressed against the image-receiving surface 110 of the flexible cover sheet 100 to print a negative image 170 of epoxy ink on the image-receiving surface 110 (step 610, FIG. 6), as shown in FIG. 2. The negative image 170 can include multiple color images sequentially printed with different silk screens to render a blended color image.

It should be noted that other forms of printing techniques, such as thermal sublimation printing and ink jet printing, can also be used to print the negative image 170 on the image-receiving surface 110 of the flexible cover sheet 100.

In some embodiments, a positive image can be first printed on a transfer sheet, for example, by thermal dye sublimation printing, and then transferred to form the negative image 170 on the image-receiving surface 110 of the flexible cover sheet 100 under heat and pressure. The dye molecules diffuse into the structure of the plastic to sufficient depth to become cohesive.

After printing, the flexible cover sheet 100 is cut to a specified width and length which are compatible with the outer surface of the sports shaft while taking into account with the thermal expansion in the molding heat.

Next, as shown in FIG. 3, the flexible cover sheet 100 is rolled up to form a tube 300 with the negative image 170 (FIG. 2) facing inside leaving a positive image 310 visible from outside (step 620, FIG. 6). The seam 320 of the tube 300 is held by a clear tape 330 which can be made of high-temperature resistant Mylar™.

Optionally, a protective sheet (not shown) can be applied to the outer surface of the tube 300 to protect the flexible cover sheet 100 from being contaminated by resins, epoxy, or glues used during molding or assembly of the sports shaft (FIG. 4 below).

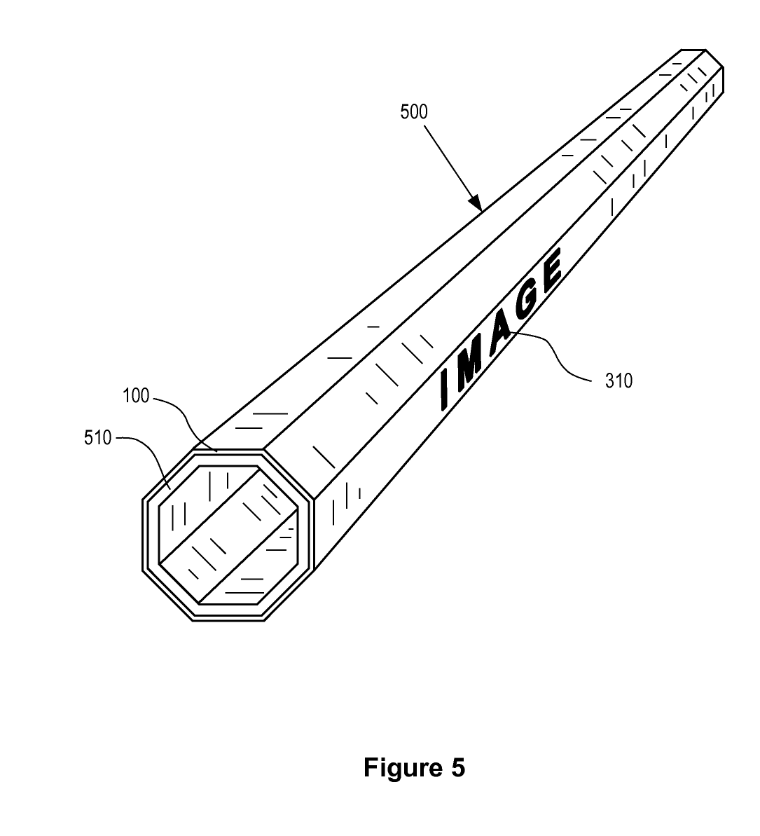

Next, referring to FIG. 4, a sports shaft is formed in a sports shaft molding apparatus 400. The sports shaft molding apparatus 400 includes a lower mold 410 and a top mold (not shown for clarity purpose) which respectively have recesses 415 that together can define the shape of the sports shaft (FIG. 5) to be formed. The shapes of the recesses 415 can define a cavity having a cross section in octagonal, square, round, or oval shape. The top mold and the lower mold 410 can have substantially the symmetric shape and can be heated by an external heater or furnace. The sports shaft molding apparatus 400 also includes an elastic inflation tube 420 that can be inflated by compressed air pumped into an air inlet 430 in fluid connection with the elastic inflation tube 420. The elastic inflation tube 420 can be made of Nylon™. The air inlet 430 can be held to the elastic inflation tube 420 by a tape 435. The top mold and the lower mold 410 also include the tube clamp 417 which can form a hole to clamp the air inlet 430 when the top mold and the lower mold 410 are held again one another.

A sheet 450 of composite material is rolled up to form a tube 460 (step 630, FIG. 6). The tube 460 is inserted inside the tube 300 formed by the flexible cover sheet 100 (step 640, FIG. 6). The nested tubes 300 and 460 are fitted into the lower mold 410. The elastic inflation tube 420 is inserted into the tube 460 formed by the sheet 450 of composite material. An upper mold (not shown) is then placed over the tube 300 of the flexible cover sheet 100 and clamped against the lower mold 410, which holds the nested tubes 300, 460 in the cavity formed by the recesses 415 in the lower mold 410 and the upper mold (not shown) (step 650, FIG. 6). The air inlet 430 is fit in the tube clamp 417. The elastic inflation tube 420 is inflated to press the tube 460 of composite material and the tube 300 formed by the flexible cover sheet 100 against the lower mold 410 and the upper mold (not shown), which causes the nested tubes 300, 460 to expand and to conform to the shapes of the recesses 415 in the lower mold 410 and the upper mold (not shown). The lower mold 410 and the upper mold (not shown) are heated to a temperature in a range such as from about 180° F. to about 325° F. The flexible cover sheet 100 in the form of the tube 300 and the sheet 450 of composite sheet in the tube 460 are co-axially molded by heat and pressure to form a multi-layer tube assembly (step 660, FIG. 6). After the applications of heat and pressure, the flexible cover sheet 100 and the sheet 450 of composite material are cured. The upper mold (not shown) is lifted. The ends of the nested tubes 300 and 460 are trimmed. The optional protective sheet (not shown) over the outer surface of the tube 300 is removed.

As shown in FIG. 5, the resulting sport shaft 500 includes a hollow composite core 510 made of the composite material from the sheet 450 (FIG. 4) wrapped by the flexible cover sheet 100 (step 670, FIG. 6). The sport shaft 500 can formed in various shapes to have cross-section in octagon, square, round, oval shapes, etc. The positive image 310 is visible from outside. The flexible cover sheet 100 provides protection to the colorants (inks or dyes) that form the positive image 310 as well as the composite core 510 underneath. An advantage of the flexible cover sheet 100 is that it has sufficient thickness and strength to prevent from being abraded and scuffed from repetitive uses so the graphics and color patterns in the positive image 310 can be protected and continuously visible from outside. Another advantage of the flexible cover sheet 100 is that it can act as a cushion and can help dampen the feel of impact to the player's hands. Additionally, the flexible cover sheet can also protect the players from sharp edges that ensue of shaft breakage as the plastic sheet tends to stretch over a breakage and prevents the shards from injuring the player or lessons the degree of injuries.

The texture of the flexible cover sheet can be chosen to provide additional friction and better hand grip. A satin or matte finish on the surface opposing the image receiving surface 110 can soften the appearance of the underlying graphics and dim the brilliance of the colors in the positive image 310, which can provide desirable cosmetic effect for some users.

As mentioned above, the flexible cover sheet 100 is not required to be transparent; the flexible cover sheet 100 can sometimes be formed by a translucent, a white, or substantially opaque material. In a thermal dye sublimation printing, the colorants in the negative image 170 (FIG. 2) can diffuse deep into the flexible cover sheet 100 in the sublimation process such that the positive image 310 is visible from outside of the sports shaft 500 (shown in FIG. 5) while being protected from resistant to scuffing and abrasions by the flexible cover sheet 100.

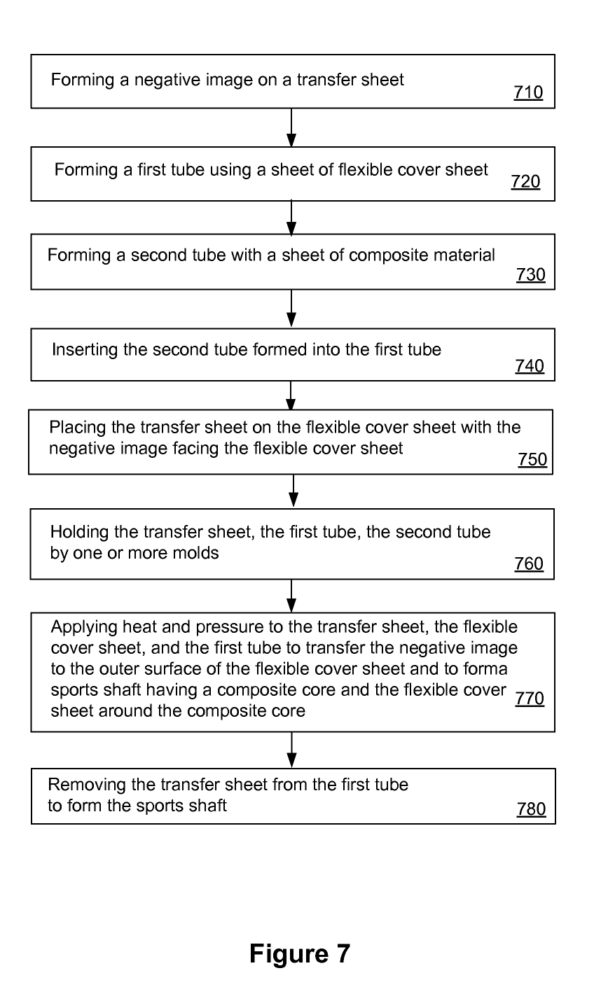

In some embodiments, the positive image 310 can be formed during the molding of the composite material in the composite core 510 and the flexible cover sheet 100. A negative image is formed on a transfer sheet using, for example, thermal dye sublimation printing (step 710, FIG. 7). A first tube is formed using a sheet of flexible cover sheet (step 720, FIG. 7) similar to the description above in relation to FIG. 3 except that flexible cover sheet is not printed with a negative image. A second tube is formed with a sheet of composite material (step 730, FIG. 7) as described above. The second tube is inserted into the first tube (step 740, FIG. 7). The transfer sheet carrying the negative image is pressed against the outer surface of the flexible cover sheet 100 (step 750, FIG. 7), which are held in the upper mold and the lower mold with the nested tubes 300 and 460 (step 760, FIG. 7), and applied with heat and pressure (step 770, FIG. 7). A positive image is formed on the outer surface of the flexible cover sheet when the flexible cover sheet and the composite material are cured by the heat and pressure to form a sports shaft (step 770, FIG. 7). The transfer sheet is removed (step 780, FIG. 7).

It should be understood that the above described methods are not limited to the specific examples used. Configurations can vary without deviating from the spirit of the invention. For example the flexible cover sheet can be formed by other types of materials than previously described. The negative or the positive images for the graphics and brand patterns can be printed with other printing techniques. The present invention is applicable to a wide range of sports shafts such as lacrosse shafts, hockey sticks, and other shaft style tools, and various shaft cross-sectional shapes such as octagon, square, round, or oval cross sections. The temperature for molding the sports shaft can vary according to the materials used.

What is claimed is:

1. A method for making a sports shaft, comprising:
forming a negative image, by a printing apparatus, on an image-receiving surface of a flexible cover sheet;
obtaining a first tube with a sheet of composite material;
covering the first tube with the flexible cover sheet that has the negative image facing an outer surface of the first tube; and
applying heat and pressure to cure the flexible cover sheet and the first tube by one or more molds to form a sports shaft having a composite core made of the composite material and the flexible cover sheet wrapped around the core and showing to the outside a positive image based on the negative image.

2. The method of claim 1, wherein the step of applying heat and pressure comprising:
holding the flexible cover sheet and the first tube inside one or more molds; and
applying pressure inside the first tube to press the first tube and the flexible cover sheet against the one or more molds.

3. The method of claim 2, further comprising:
inserting an elastic inflation tube into the first tube; and
inflating the elastic inflation tube by compressed air to press the first tube and the flexible cover sheet against the one or more molds.

4. The method of claim 1, wherein the step of applying heat and pressure comprising:
heating the flexible cover sheet and the first tube to a temperature between about 180° F. to about 325° F.

5. The method of claim 1, wherein the negative image is formed by a dye or an ink, the method further comprising:
before the step of forming a negative image, treating the image-receiving surface by heat, flame, the Corona process, sand blast, or a chemical to assist the adhesion of the dye or the ink to the image-receiving surface.

6. The method of claim 1, further comprising:
rolling the flexible cover sheet to form a second tube having the negative image facing inside, leaving the positive image visible from outside of the second tube, wherein the step of covering comprises inserting the first tube into the second tube.

7. The method of claim 1, wherein the flexible cover sheet is formed by a material selected from the group consisting of a polymeric or a plastic material such as Nylon™, Polybutylene terephthalate (PBT), and co-extruded Nylon™ and PBT.

8. The method of claim 1, wherein the flexible cover sheet is formed by a substantially transparent material.

9. The method of claim 1, wherein the flexible cover sheet is formed by a translucent, a white, or substantially opaque material.

10. The method of claim 1, wherein the flexible cover sheet has a thickness a range between about 0.01″ and about 0.04″.

11. The method of claim 1, wherein the flexible cover sheet has a satin or matte finish on a cover surface opposing to the image-receiving surface.

12. The method of claim 1, wherein the negative image is formed on the image-receiving surface of a flexible cover sheet using silk screen printing, ink jet printing or thermal dye sublimation printing.

13. A method for making a sports shaft, comprising:
forming a negative image on a transfer sheet by a printing apparatus;
forming a first tube with a sheet of composite material;
covering the first tube by a flexible cover sheet;
placing the transfer sheet on the flexible cover sheet with the negative image facing an outer surface of the flexible cover sheet;
applying heat and pressure to the flexible cover sheet and the first tube by one or more molds to cure the flexible cover sheet and the composite material in the first tube and to transfer the negative image to the outer surface of the flexible cover sheet; and
removing the transfer sheet from the flexible cover sheet to form a sports shaft having a composite core made of the composite material and a flexible cover sheet wrapping around the core, wherein the outer surface of the flexible cover sheet is printed with a positive image based on the negative image.

14. The method of claim 13, wherein the step of applying heat and pressure comprising:
holding the flexible cover sheet and the first tube inside one or more molds; and
applying pressure inside the first tube to press the first tube, the flexible cover sheet, and the transfer sheet against the one or more molds.

15. The method of claim 14, further comprising:
inserting an elastic inflation tube into the first tube; and
inflating the elastic inflation tube by compressed air to press the first tube, the flexible cover sheet, and the transfer sheet against the one or more molds.

16. The method of claim 13, further comprising:
rolling the flexible cover sheet to form a second tube, wherein the step of covering comprises inserting the first tube into the second tube.
